(19) United States
(12) Patent Application Publication
(10) Pub. No.: US 2014/0286697 A1
(43) Pub. Date: Sep. 25, 2014

(54) Method for Manufacturing Joint Member

(71) Applicant: TEIJIN LIMITED, Osaka (JP)

(72) Inventors: Masaki Takeuchi, Matsuyama-shi (JP); Takumi Kato, Matsuyama-shi (JP)

(73) Assignee: TEIJIN LIMITED, Osaka (JP)

(21) Appl. No.: 14/297,911

(22) Filed: Jun. 6, 2014

Related U.S. Application Data
(63) Continuation of application No. PCT/JP2012/081568, filed on Dec. 5, 2012.

(30) Foreign Application Priority Data
Dec. 6, 2011 (JP) 2011-266899

(51) Int. Cl. B29C 65/08

(52) U.S. Cl. CPC B29C 65/08
USPC 403/270; 156/73.1; 156/73.6

(57) ABSTRACT

There is provided a method for manufacturing a joint member including two or more carbon fiber composite materials having a thermoplastic resin as a matrix, characterized in that while heating and melting or after heating and melting at least one joining portion A of the composite materials, the one joining portion A is brought into contact with other joining portion B of the composite materials, and the joining portions A and B are welded by giving vibration or ultrasonic vibration while applying a pressure.

### CROSS REFERENCE TO RELATED APPLICATION

This is a continuation of International Application No. PCT/JP2012/081568 filed on Dec. 5, 2012, and claims priority from Japanese Patent Application No. 2011-266899, filed on Dec. 6, 2011, the entire disclosures of which are incorporated herein by reference.

### TECHNICAL FIELD

The present invention relates to a method for manufacturing a joint member including a carbon fiber composite material containing a thermoplastic resin, a joint member obtained by the manufacturing method, and a method for joining carbon fiber composite materials.

### BACKGROUND ART

A carbon fiber composite material has high specific strength and specific rigidity, and is valued as an extremely excellent material. In general, mechanical joining such as bolt/nut and rivet, or joining which an adhesive is used is employed to join carbon fiber composite materials. In a joint member of carbon fiber composite materials having end surfaces, the area of a joined portion is small. Therefore, for the purpose of preventing separation or slippage of the end surfaces, the carbon fiber composite materials needs to be joined together with, for example, a guide having an L-shaped cross section, or an adhesive need to be overlaid at corners as described in Patent Document 1. This becomes the cause of increasing a mass or increasing steps. Furthermore, an adhesive generally requires time until obtaining practical strength. Therefore, a curring step must be considered. If carbon fiber composite materials can be directly joined with each other at the respective end surfaces as they are, an overlapping potion where materials are layered is not required. Therefore, reduction in weight can be expected. On the other hand, carbon fiber composite materials using a thermoplastic resin as a matrix are joined by welding with each other within a compatibilization range of the resins, and joining strength comparable to that of the matrix resin can be expected. Patent Document 2 describes that fibers in a welded joining portion of carbon fiber composite materials are entangled, and thereby strength is further enhanced.

### CITATION LIST

### Patent Document

Patent Document 1: JP-A-2004-200150

Patent Document 2: JP-A-H11-90986

### SUMMARY OF INVENTION

### Problems to be Solved by the Invention

An object of the present invention is to provide a method for manufacturing a joint member, in which in joining two or more carbon fiber composite materials having a thermoplastic resin as a matrix, at least one member is joined at an end surface (edge), and to provide one method for manufacturing a joint member of a wide variety of carbon fiber composite materials. Patent Document 2 describes that in overlapping plates in a thickness direction of the plates and welding them, each plate is welded after being melted to expose carbon fibers. However, in the case where at least one member to be joined is joined at its end surface, the area of the melted portion is small, and it has been difficult to impart sufficient strength.

Accordingly, the present invention has an object to provide a method for manufacturing a joint member having rigid mechanical strength in a joining portion, the joint member including two or more carbon fiber composite materials having a thermoplastic resin as a matrix, and a method for joining carbon fiber composite materials. The present invention further provides a joint member excellent in joining strength obtained by the manufacturing method of the present invention.

### Means for Solving the Problems

The present inventors have found that as a result of intensive investigations on the joining including an end surface in at least one of carbon fiber composite materials in joining carbon fiber composite materials containing a thermoplastic resin with each other, when portions to be joined are brought into contact with each other while being heated and melted and then are welded by giving vibration or ultrasonic vibration while applying a pressure, joining strength of the joining portion is increased. Thus the present inventors have reached the present invention.

That is, the present invention is described below.

[1] A method for manufacturing a joint member including two or more carbon fiber composite materials containing a thermoplastic resin as a matrix, characterized in that while heating and melting or after heating and melting at least one joining portion A of the carbon fiber composite materials, the one joining portion A is brought into contact with another joining portion B of the carbon fiber composite materials, and the joining portions A and B are welded by giving vibration or ultrasonic vibration while applying a pressure.
[2] The method for manufacturing a joint member according to [1], wherein carbon fibers contained in at least one carbon fiber composite material is discontinuous fibers having an average fiber length of 1 to 100 mm.
[3] The method for manufacturing a joint member according to [1] or [2], wherein the heating and melting are conducted by near infrared rays.
[4] The method for manufacturing a joint member according to any one of [1] to [3], wherein the carbon fiber composite material contains the thermoplastic resin in an amount of 50 to 1,000 parts by mass per 100 parts by mass of the carbon fibers.
[5] The method for manufacturing a joint member according to any one of [1] to [4], wherein at least one of the joining portions A and B is a thickness side wall of the carbon fiber composite material.
[6] A joint member obtained by the manufacturing method of any one of [1] to [5], wherein the two or more carbon fiber composite materials containing the thermoplastic resin as a matrix are joined with each other in a joint strength of 10 MPa or more.
[7] A method for joining two or more carbon fiber composite materials having a thermoplastic resin as a matrix, characterized in that while heating and melting or after heating and melting at least one joining portion A of the carbon fiber composite materials, the one joining portion A is brought into contact with another joining portion B of the carbon fiber composite materials, and

the joining portions A and B are welded by giving vibration or ultrasonic vibration while applying a pressure.

### Advantageous Effects of Invention

According to the present invention, a rigid and stable joint member can be obtained in the joining of end surfaces of members including carbon fiber composite materials having a thermoplastic resin as a matrix.

### BRIEF DESCRIPTION OF DRAWINGS

FIG. 1 is a schematic view of one example of a joint member, for explaining one embodiment of the present invention.

FIG. 2 is a schematic view of other example of a joint member, for explaining one embodiment of the present invention.

FIG. 3 is a view showing an optical microphotograph of a cross section in a joining portion of the joint member in Example 1.

FIG. 4 is a schematic view of one example of a heating method, for explaining one embodiment of the present invention.

FIG. 5 is a schematic view of one example of a heating method, for explaining one embodiment of the present invention.

### EMBODIMENTS FOR CARRYING OUT THE INVENTION

The embodiment of the present invention is described below.

The method for manufacturing a joint member of the present invention is a method for manufacturing a joint member including two or more carbon fiber composite materials having a thermoplastic resin as a matrix, wherein while heating and melting or after heating and melting at least one joining portion A of the composite materials, the one joining portion A is brought into contact with other joining portion B of the composite materials, and the joining portions A and B are welded by giving vibration or ultrasonic vibration while applying a pressure.

The method for joining carbon fiber composite materials of the present invention is a method for joining two or more carbon fiber composite materials having a thermoplastic resin as a matrix, wherein while heating and melting or after heating and melting at least one joining portion A of the composite materials, the one joining portion A is brought into contact with other joining portion B of the composite materials, and the joining portions A and B are welded by giving vibration or ultrasonic vibration while applying a pressure.

The embodiment of the present invention is described below.

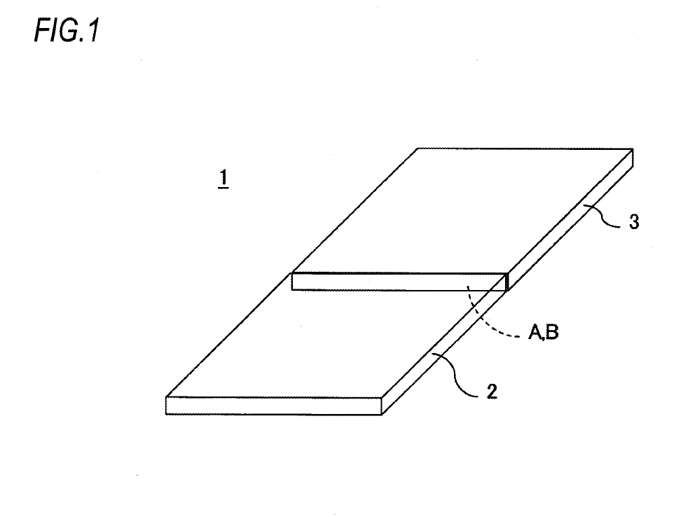

A joint member 1 shown in FIG. 1 is a flat plate-like joint member formed by joining two flat plate-like carbon fiber composite materials 2 and 3 containing a thermoplastic resin at their thickness side walls (end surfaces) A and B. While heating and melting or after heating and melting the joining portion (end surface) A of one carbon fiber composite material 2 or the joining portions (end surfaces) A and B of the carbon fiber composite materials 2 and 3, the joining portions A and B of the carbon fiber composite materials 2 and 3 are brought into contact with each other, and the joining portions A and B of the carbon fiber composite materials 2 and 3 are then welded by giving vibration while applying a pressure, and thereby the carbon fiber composite materials 2 and 3 are joined.

### Carbon Fiber Composite Material

The carbon fiber composite material containing a thermoplastic resin used in the present invention (sometimes simply referred to as a “carbon fiber composite material”) is a material including a thermoplastic resin as a matrix and carbon fibers contained in the matrix. The carbon fiber composite material preferably contains the thermoplastic resin in an amount of 50 to 1,000 parts by mass per 100 parts by mass of the carbon fibers. The amount of the thermoplastic resin contained is more preferably 50 to 400 parts by mass, and still more preferably 50 to 100 parts by mass, per 100 parts by mass of the carbon fibers. Where the amount of the thermoplastic resin is less than 50 parts by mass per 100 parts by mass of the carbon fibers, a portion in which the carbon fibers in the composite material do not come into contact with the thermoplastic resin is generated, and this may lead to disadvantage on the production of the composite material. On the other hand, where the amount of the thermoplastic resin exceeds 1,000 parts by mass, the content of the carbon fibers becomes too small, and the effect of improving properties such as mechanical strength due to presence of the carbon fibers may become insufficient.

Examples of the thermoplastic resin include at least one selected from the group consisting of polyamide, polycarbonate, polyester (specific examples: polyethylene terephthalate, polybutylene terephthalate and polyethylene naphthalate), polyoxymethylene, polyphenylene sulfide, polyphenylene ether, modified polyphenylene ether, polyethylene, polypropylene, polystyrene, polymethyl methacrylate, AS resin, ABS resin, and mixtures (resin compositions) of two or more selected from those resins. Particularly, at least one selected from the group consisting of polyamide, polypropylene, polycarbonate, polyester, polyphenylene sulfide, and mixtures of two or more selected from those resins is preferred from the balance between costs and properties. Polyamide or polyester is more preferred.

The resin composition is more preferably at least one selected from the group consisting of a composition of polycarbonate and polyester, a composition of polycarbonate and ABS resin, a composition of polyphenylene ether and polyamide, a composition of polyamide and ABS resin, and a composition of polyester and polyamide.

Functional fillers and additives may be contained in the carbon fiber composite material in an amount that the object of the present invention is not impaired. Examples of the functional fillers and additives include organic/inorganic fillers, a flame retardant, a UV-resistant agent, a pigment, a release agent, a softener, a plasticizer and a surfactant, but the invention is not limited to those.

A form of carbon fibers in the carbon fiber composite material is not particularly limited. A fiber sheet containing a woven fabric or knitted fabric including continuous fibers and a material obtained by arranging continuous fibers in one direction and joining those with a resin (unidirectional material) can be used. In the case of using the unidirectional material, a stacked body obtained by stacking a plurality of the unidirectional materials in a desired direction in a specific condition such as varying the direction of the fibers in each of the unidirectional materials can be formed. The stacked body is preferably formed by stacking surfaces being symmetrically arranged in a thickness direction.

In the carbon fiber composite material, discontinuous carbon fibers may be dispersed randomly, that is, uniformly and isotropically, in a plane direction and arranged such that at least a part of the carbon fibers is overlapped. The carbon fibers may be present as a fiber bundle. In this case, the lower limit of the average fiber length is 1 mm, preferably a range of 5 mm or more and 100 mm or less, and more preferably more than 5 mm and less than 100 mm. The upper limit of the average fiber length is preferably 50 mm. The carbon fibers are preferably discontinuous carbon fibers, and the discontinuous carbon fibers are entangled with carbon fibers in other composite material in the joining portion of the joint member, and thereby high strength is developed. The carbon fibers are more preferably discontinuous fibers having an average fiber length of 5 to 100 mm. Fibers other than the “discontinuous fibers” are called “continuous fibers”.

The average fiber length was obtained as follows. Lengths of 100 carbon fibers randomly extracted were measured down to 1 mm unit and recorded with a vernier caliper or a loupe, and the average fiber length (La) was obtained by the following formula from the measured lengths (Li wherein i is an integer of 1 to 100) of all of the carbon fibers.

La=ΣLi/100

The carbon fibers used in the present invention has preferably the average fiber length within the above range, and discontinuous fibers having a length of less than 1 mm or discontinuous fibers having a length exceeding 100 mm may be contained in a content of 20 mass % or less based on the total mass of the carbon fibers. Since these fibers may affect the joining, it is preferred that they are not substantially contained.

The carbon fibers may be subjected to a surface treatment such as a treatment with a coupling agent, a treatment with a sizing agent or an adhesion treatment of additives. The carbon fibers may be used in one kind alone and may be used in two kinds or more.

In the case of the discontinuous carbon fibers, the carbon fibers may be present in the state of carbon fiber bundles in the composite material, and preferably in the state where a carbon fiber bundles and single fibers are mixed. It is preferred that the discontinuous carbon fibers are two-dimensionally randomly arranged in an in-plane direction in the composite material. When the discontinuous carbon fibers are two-dimensionally randomly arranged, the carbon fiber composite materials and a joint member made from the composite materials have dynamically isotropy in an in-plane direction, and therefore are excellent in mechanical strength and the balance thereof in the in-plane direction (hereinafter sometimes referred to as a “random material”).

In the carbon fiber composite material, the carbon fibers mainly spread in a plane direction, and the content of carbon fibers toward a thickness direction is relatively small. Therefore, it is considered that when a welding at the end surface of the carbon fiber composite material, as described after, is performed, carbon fibers become inserted state, and the carbon fibers are entangled by further melting and giving vibration and high strength is developed.

In the present invention, it is preferred that at least one of the carbon fiber composite materials used for joining is a composite material including one random material or a plurality of the random materials stacked. The random material tends to be entangled with carbon fibers in other carbon fiber composite material during joining, and therefore has excellent joining strength. The other carbon fiber composite material may contain continuous fibers in which carbon fibers are a woven fabric, a knitted fabric or a unidirectional material, and may contain discontinuous fibers which are not two-dimensional random. More preferably, both one and other carbon fiber composite materials use the random material. A material obtained by stacking a fiber sheet containing one or more layer of a woven fabric or knitted fabric comprising the continuous fibers or a unidirectional material, on one side or both sides of the random material, may be used.

A method for producing the carbon fiber composite material is not particularly limited. For example, pellets (short fiber pellets or long fiber pellets) obtained by covering short fibers having a length of 100 mm or less, carbon fibers (carbon long fibers) having a length exceeding 100 mm or continuous fibers with a thermoplastic resin and cutting this, that is, short fiber pellets or long fiber pellets obtained by the step of adjusting molten thermoplastic resin to a predetermined viscosity, impregnating continuous carbon fiber with the thermoplastic resin, and then cutting, are used, and the pellets can be molded into a given shape such as a sheet with an injection molding machine. Furthermore, a material in the state that continuous fibers or discontinuous carbon fibers, continuous fibers or discontinuous fibers, and a thermoplastic resin in continuous fibers or discontinuous fibers form such as a woven fabric, a knitted fabric, in a powder form, in a film form, or in a molten state, have been mixed or stacked is first prepared, and this material is then heated and pressurized to produce a sheet-like impregnated molding. The single layer or multilayer of the molding is subjected to pressure molding such as pressing, thereby a composite material having a desired shape can be obtained.

### Welding Method

In the method for manufacturing a joint member of the present invention, while heating and melting or after heating and melting at least one joining portion A of the composite materials, the one joining portion A is brought into contact with other joining portion B of the composite materials, and the joining portions A and B are welded by giving vibration or ultrasonic vibration while applying a pressure.

Preferably, the joining (end surface joining) in which at least one joining portion of the carbon fiber composite materials to be joined is melted by a heating method such as near infrared rays, and joining portions are brought contact with each other after melting or substantially simultaneously with melting. Thereafter, vibration or vibration by ultrasonic waves is imparted to the joining portion while applying a pressure, and after stopping the vibration, the joining portion is cooled while maintaining the pressurization, and thereby the joining can be achieved. The end surface joining means that a thickness portion of a material or a surface portion at the tip of a structure such as a lib or a boss is directly joined to a flat surface portion or end surface of a facing material.

It is preferred that at least one of the joining portions A and B is an end (thickness side wall) of the carbon fiber composite material.

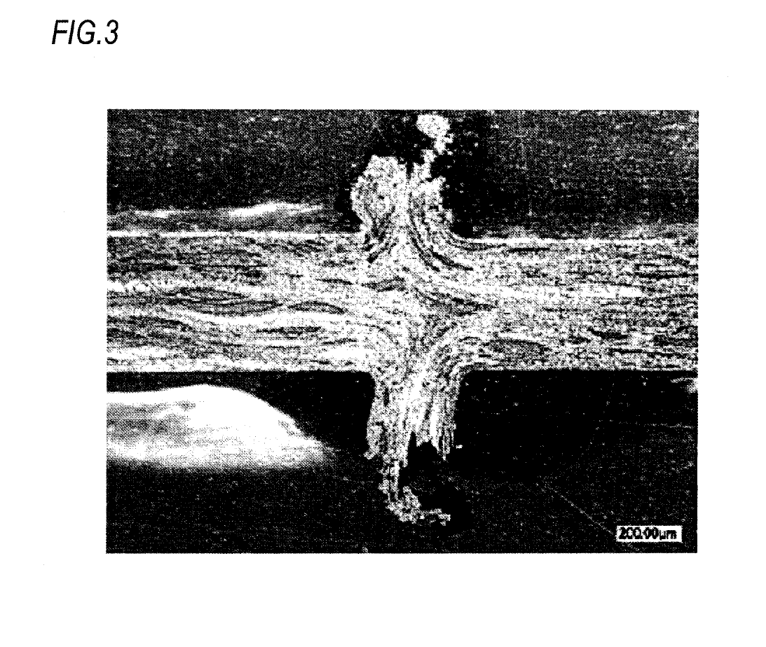

The joining portions of the composite materials are integrated with each other by the combination of heating/melting, pressurization and vibration welding. In welding the joining portions A and B, the joining portions are preferably joined while applying a pressure. By the welding and joining, the carbon fibers contained in one composite material move and enter the inside of other composite material as shown in FIG. 3, and preferably a part of the carbon fibers of the respective composite materials is entangled, and thereby giving a joint member having enhanced joining strength.

The heating method and means are not particularly limited.

The “heating and melting” used herein means the state that the resin in the joining portion becomes a molten state by heating, and the carbon fibers present in a fixed state by the thermoplastic resin in the composite material are released and become free. When a pressure is applied in the state, the carbon fibers enter into a composite material in a molten state of other joining portion. By further giving vibration or ultrasonic vibration, the carbon fibers in a free state move, and the carbon fibers in the composite materials can be entangled with each other. The viscosity of the resin during heating and melting is a range of preferably 10 to 1,000 Pa·s, and more preferably 10 to 200 Pa·s.

The heating method is preferably heat transmission or radiation by a heating body such an external heater. Radiation by infrared rays is particularly preferred. The infrared rays are preferably near infrared rays that are an absorption region of a matrix resin. Specifically, its wavelength is a range of preferably 750 or more and 4,000 nm or less, and more preferably 2,000 to 4,000 nm.

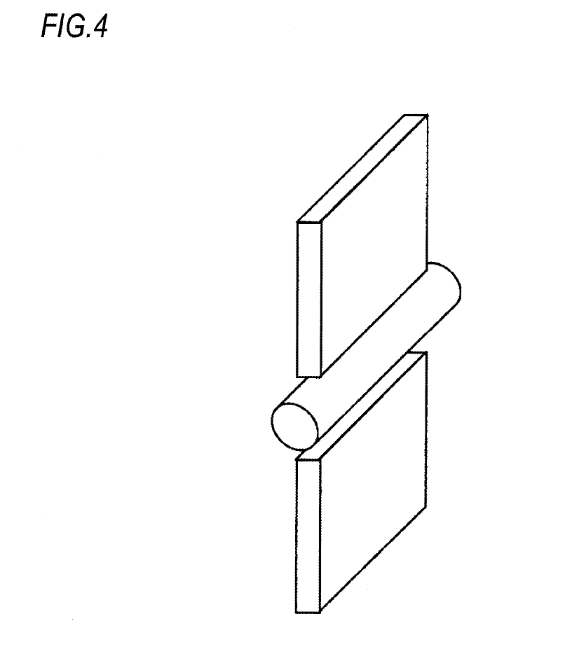

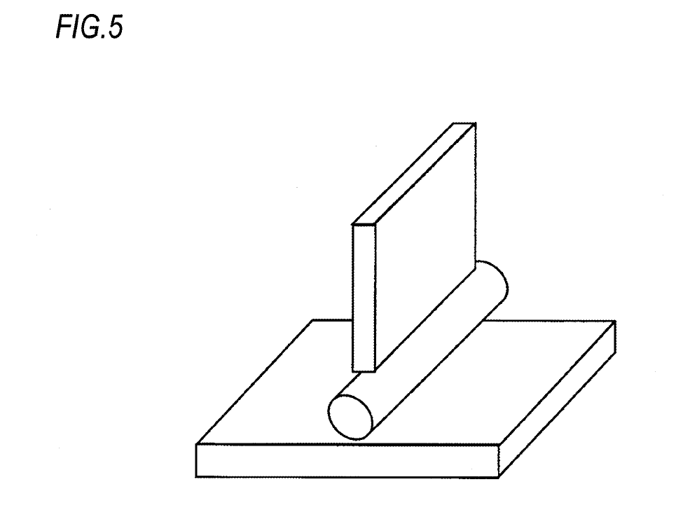

The heating method is not particularly limited. For example, joining portions of a plurality of materials to be heated may be heated with one heating body, and may be heated every material to be heated using a plurality of heating bodies, respectively. The distance between the heating body and the material to be heated is not limited. In the case where the material to be heated is desired to be rapidly heated, the distance is short, thereby shortening a heating time. In the case where the heating body is an infrared heater, diffused light can be reflected and concentrated. However, optimum distance can be set by a design of a reflector. A size of the heating body is not particularly limited, and the heating body suitable for the size of the joining portion of the material to be heated is designed. One example of the heating method is shown in FIG. 4 and FIG. 5. A columnar heating body is specifically shown as the heating body in FIGS. 4 and 5, but the heating body may be a rod-shaped or a planar heating body. Any heating body can be used so long as the joining portion of the material to be heated can be uniformly heated. Therefore, a cross section of the shape of the heating body may be a circular shape, an elliptical shape or a polygonal shape.

The heating temperature is a melting temperature or higher of the thermoplastic resin, but is preferably set such that the thermoplastic resin does not flow out of the carbon fiber composite material. The heating temperature is more preferably (melting temperature+15° C.) or more and (melting temperature+100° C.) or less, and still more preferably (melting temperature+15° C.) or more and (melting temperature+50° C.) or less. The carbon fiber composite material is a material having extremely excellent thermal conductivity, but the thermal conductivity varies depending on a size or thickness thereof. Therefore, the heating time is about 1 second to 10 minute. In the molten state, the matrix resin is generally liable to thermally decompose and change its nature. Therefore, it is not preferred that the state is maintained for a long period of time. As one example, in the case of heating nylon 6 or nylon 6,6 with an infrared heater, where the temperature of the infrared heater is about 1,000° C. and the clearance between the infrared heater and the carbon fiber composite material is 1 cm, the heat irradiation time is preferably a range of 1 to 50 seconds. In the carbon fiber composite material that is a material to be heated, the surface temperature is preferably 235° C. to 320° C., and the joining time at 275° C. is preferably about 5 minutes or less.

As a pressurization condition, a pressure of preferably 0.01 to 2 MPa, more preferably 0.02 to 1.5 MPa, and still more preferably 0.05 to 1 MPa is applied to the welded surface. Where the pressure is less than 0.01 MPa, a good joining strength may not be obtained. Additionally, the composite material causes spring-back during heating, the shape cannot be maintained, and strength of the joint member may be decreased, in some cases. On the other hand, where the pressure exceeds 2 MPa, the pressurized portion may be crushed, thereby making it difficult to maintain the shape, and strength of the joint member obtained may be decreased.

The welding method is preferably welding by vibration or welding by vibration using ultrasonic wave. These welding are conducted in a vibration range of 50 Hz to 100 kHz. In the case of the vibration welding, a range of about 100 to 300 Hz is preferred, and in the case of the ultrasonic vibration, a range of 10 to 50 kHz is preferred. The total number of vibrations is preferably 300 to 10,000 in the case of the vibration welding and 10,000 to 150,000 in the case of the ultrasonic vibration. It is considered that carbon fibers from both side surfaces are entangled with each other in particularly the end surface joining potions by the vibration or ultrasonic wave, and this is extremely preferred in joint strength. It is important that the carbon fibers are present at the interface of the joining portions, and it is considered that entanglements of the carbon fibers from both end surfaces occurs in the softened thermoplastic resin, thereby joint strength of the joining portions is further increased.

Where without the above heating such as melting the thermoplastic resin, only vibration or ultrasonic vibration is conducted, the carbon fibers are bent particularly in the joining portions by a shock of vibration surface, the carbon fibers may not be sufficiently present at the interface of the joining portions, and the joint strength is not sufficient.

### Joint Member

The joint member of the present invention includes a combination of two or more carbon fiber composite materials, and is not limited to the flat plate-like joint member 1 described above.

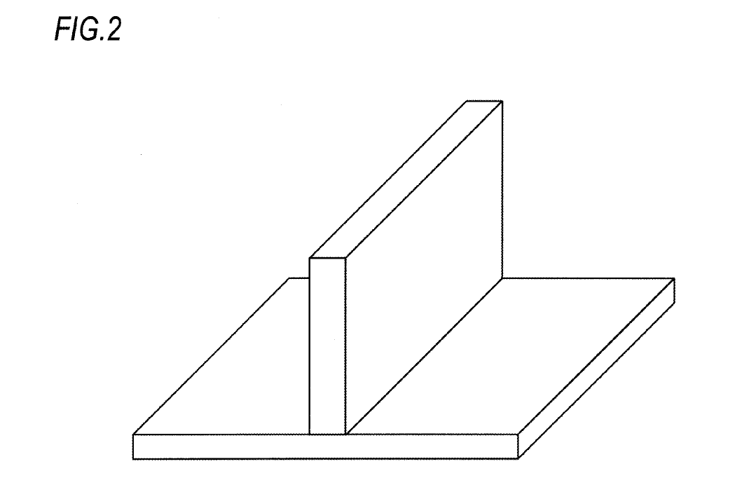

The shape of the carbon fiber composite material used is a shape depending on its use and a joining portion. For example, a flat plate material or the like, in which two flat plates made from a carbon fiber composite material are joined at each thickness surface, a box-like material including a combination of flat plates, and the like, may be exemplified. As shown in FIG. 2, a joint member in the form where a side surface of the thickness surface of one or more carbon fiber composite material is joined with a flat surface of one flat plate-like carbon fiber composite material to be reinforced by a vertical rib is exemplified. Alternatively, the composite material to be joined to a flat surface of one flat plate may be a columnar shape material in which the joint surface is a flat surface, or the like. In conducting vibration welding, it is important that the joint surface vibrates such that the carbon fiber composite materials are uniformly brought into contact with each other, and the joint surface may be a curved surface. The joint surface is preferably a flat surface. When the joint surface is a flat surface, because the joint surface is previously heated until softening, the joint surfaces thermoplastically deform and are uniformly brought into contact with each other in being contact with each other and giving vibration to the contacted portion, and this is preferred.

The size of the joint surface of the joining portion is not particularly limited. For example, in the case where one of the carbon fiber composite materials to be joined has a flat surface shape, its side surface of the thickness side wall is desired to be joined, and (i) the thickness side wall is joined with a thickness side wall of other carbon fiber composite material, the thickness of those carbon fiber composite materials is preferably 0.5 to 20 mm, and more preferably 0.5 to 50 mm. When the thickness is 0.5 mm or more, the joining can be stably performed.

In the case where one of the carbon fiber composite materials to be joined has a flat surface shape, its thickness side wall is desired to be joined, and (ii) the thickness side wall is joined with a flat surface portion of other carbon fiber composite material, the thickness of the one of the carbon fiber composite material is preferably 0.5 to 20 mm, and more preferably 0.5 to 50 mm. When the thickness is 0.5 mm or more, the joining can be stably performed. In the case of joining two carbon fiber composite materials at the respective surfaces thereof, the area is preferably 1 mm² or more, and more preferably 10 mm² or more. The upper limit is not particularly limited, but is about 1,000,000 mm².

The present invention relates to a joint member in which carbon fiber composite materials are joined with each other in a joint strength of 10 MPa or more, obtained by the manufacturing method described above.

The joint member in which carbon fiber composite materials are joined with each other in a joint strength of 10 MPa or more can be obtained by the present invention, and can be preferably used as, for example, a structural member for vehicle bodies, that requires strength. It is presumed that because fibers from the carbon fiber composite materials are entangled in the joining portion, the joint strength is excellent. Such a structural member includes parts constituting mobile objects such as automobiles. The joint strength can be evaluated by, for example, a tensile test.

### EXAMPLES

The present invention is specifically described below based on examples, but it should be understood that the invention is not construed as being limited to those.

1. Heating apparatus: An infrared heater that radiates infrared rays having a wavelength region of about 2,000 to 4,000 nm centering 3,000 nm from an electric heating wire having the output of 1 kW was used.
2. Observation of cross section: Cross section of a joining portion was observed with a microscope (VHX-1000) manufactured by Keyence Corporation.
3. Tensile test: An Instron 5587 Universal Testing System was used, a sample was set such that a welding surface is vertical to a tensile direction, and a tensile test was conducted in a tensile rate of 1 mm/min.

### Reference Example

### Production of Flat Plate Including Random Material

Carbon fibers (TENAX STS40 manufactured by Toho Tenax Co., Ltd., average fiber diameter: 7 μm) were cut such that an average fiber length is 16 mm. The carbon fibers were arranged by randomly dispersing on a flat surface such that an average fiber areal weight is 540 g/m². Those were alternately interposed among 10 Unitika KE435-POG clothes (fabric of nylon 6 (melting point: 225° C.)). The resulting stacked body was pressed at 260° C. under a pressure of 2.5 MPa to prepare a flat plate including a carbon fiber composite material (random material) having a carbon fiber volume of 35%, 1,400 mm×700 mm, and a thickness of 2 mm.

### Example 1

The flat plate obtained in Reference Example was cut into two sheets each having a length of 100 mm and a width of 25 mm. One of thickness side surfaces of 100 mm width of the respective sheets was irradiated with near infrared rays from a position of 1 cm apart from the side surface for about 10 seconds to increase a surface temperature of the random material to 275° C. The positional relationship between the joining portions of the two flat plates and the infrared heater is shown in FIG. 4. In this case, the viscosity of the thermoplastic resin of the random material (material to be heated) was about 180 Pa·s. The molten thickness side surfaces of the two random materials were allowed to be vibrated in a horizontal direction having the amplitude of 1.5 mm and 240 Hz while applying a pressure of 1 MPa by a cylinder utilizing an air pressure of 0.2 MPa. The joined material was allowed to stand (for 10 seconds) while applying a pressure, and then cooled to room temperature. A joint cross section of the joint member piece obtained was observed. As a result, it was seen that the carbon fibers in the random material were entangled with each other as shown in FIG. 3 (burr formed by the joining is shown). Five sets of the joint member were prepared, burr was removed, and a tensile test was conducted so as to vertically tear off the joint surface. As a result, an average value of joint strength was 35 MPa.

### Example 2

Five sets of the joint member were prepared in the same manner as in Example 1 except that the vibration is vertical vibration (ultrasonic vibration) of 20 kHz. A tensile test was conducted so as to vertically tear off the joint surface. As a result, an average value of joint strength was 23 MPa.

### Comparative Example 1

Five sets of the joint member were prepared in the same manner as in Example 1 except that near infrared irradiation is not conducted. A tensile test was conducted so as to vertically tear off the joint surface. As a result, an average value of joint strength was 9 MPa.

### Example 3

The flat plate including a random material obtained in Reference Example was cut into two sheets each having a length of 100 mm and a width of 25 mm. A thickness side surface having a side of 100 mm length of one sheet was used as a joint surface, and a flat surface of 100 mm×25 mm of other sheet was used as a joint surface. One flat surface portion was used as an end surface as shown in FIG. 2. The positional relationship between the joining portions of two flat plates and an infrared heater is shown in FIG. 5. Similar to Example 1, after heating the thickness side surface and the end surface, the heater was immediately removed, those surfaces were appressed under a pressure and a vibration was applied thereto. Thus, five sets in total were prepared. A tensile test was conducted so as to vertically tear off the joint surface. As a result, an average value of joint strength was 20 MPa.

### Example 4

Carbon fibers (TENAX STS40 manufactured by Toho Tenax Co., Ltd., average fiber diameter: 7 μm) were cut into an average fiber length of 16 mm. The carbon fibers were randomly arranged such that an average fiber areal weight is 540 g/m². Powdery polybutylene terephthalate (VALOX manufactured by SABIC) pulverized into an average particle diameter of 1 mm was uniformly mixed with the carbon fibers such that the weight proportion is 55%, followed by pressing at 260° C. under a pressure of 2.5 MPa. Thus, a flat plate including a carbon fiber composite material having a size of 1,400 mm×700 mm and a thickness of 2 mm was prepared. Two sample pieces each having a size of 50 mm×55 mm was cut off from the flat plate. Similar to Example 1, one surface of thickness side surfaces of the respective sample pieces was irradiated with near infrared rays for about 10 seconds from a position of 1 cm apart from the one surface to increase the surface temperature of the random material to 275° C. Thereafter, the heater was immediately removed, those surfaces were appressed under a pressure (2 MPa), and a vibration in a horizontal direction having the amplitude of 1.5 mm and 240 Hz was applied for 10 seconds. The joined material was allowed to stand (for 10 seconds) while applying a pressure, and then cooled. A Joint cross section of the joint member piece obtained was observed. As a result, it was seen that the carbon fibers in the random material were entangled with each other, similar to FIG. 3. Five sets of the joint member were prepared. A tensile test was conducted so as to vertically tear off the joint surface. As a result, an average value of joint strength was 20 MPa.

### Example 5

Carbon fibers (TENAX STS40 manufactured by Toho Tenax Co., Ltd., average fiber diameter: 7 μm) were cut into an average fiber length of 16 mm. The carbon fibers were randomly arranged such that an average fiber areal weight is 540 g/m². Powdery polyphenylene sulfide (FORTRON (registered trademark) manufactured by Polyplastics Co., Ltd.) pulverized into an average particle diameter of 1 mm was uniformly mixed with the carbon fibers such that the weight proportion is 55%, followed by pressing at 310° C. under a pressure of 2.5 MPa. Thus, a flat plate including a carbon fiber composite material having a size of 1,400 mm×700 mm and a thickness of 2 mm was prepared. Two sample pieces each having a size of 50 mm×55 mm was cut off from the flat plate. Similar to Example 1, one surface of thickness side surfaces of the respective sample pieces was irradiated with near infrared rays for about 15 seconds from a position of 1 cm apart from the one surface to increase the surface temperature of the random material to 320° C. Thereafter, the heater was immediately removed, those surfaces were appressed under a pressure (2 MPa), and a vibration in a horizontal direction having the amplitude of 1.5 mm and 240 Hz w was applied for 10 seconds. The joined material was allowed to stand (for 10 seconds) while applying a pressure, and then cooled. A joint cross section of the joint member piece obtained was observed. As a result, it was seen that the carbon fibers in the random material were entangled with each other, similar to FIG. 3. Five sets of the joint member were prepared. Tensile test was conducted so as to vertically tear off the joint surface. As a result, an average value of joint strength was 22 MPa.

The case of joining a plurality of carbon fiber composite materials at end surfaces has been described above as an example. However, the present invention is useful to the case of, for example, joining two flat plate-like carbon fiber composite materials containing a thermoplastic resin by overlapping the respective ends thereof.

### INDUSTRIAL APPLICABILITY

According to the present invention, a method for manufacturing a joint member in which a joining portion has strong mechanical strength, the joint member including two or more carbon fiber composite materials having a thermoplastic resin as a matrix, and a method for joining carbon fiber composite materials can be provided. Furthermore, a joint member having excellent joint strength obtained by the manufacturing method of the present invention is provided.

Although the present invention has been described in detail and by reference to the specific embodiments, it is apparent to one skilled in the art that various modifications or changes can be made without departing the spirit and scope of the present invention.

This application is based on Japanese Patent Application No. 2011-266899 filed Dec. 6, 2011, the disclosure of which is incorporated herein by reference.

What is claimed is:

1. A method for manufacturing a joint member comprising two or more carbon fiber composite materials containing a thermoplastic resin as a matrix,
wherein while heating and melting or after heating and melting at least one joining portion A of the carbon fiber composite materials, the one joining portion A is brought into contact with another joining portion B of the carbon fiber composite materials, and
the joining portions A and B are welded by giving vibration or ultrasonic vibration while applying a pressure.

2. The method for manufacturing a joint member according to claim 1,
wherein the joining portions A and B are a flat plane.

3. The method for manufacturing a joint member according to claim 1,
wherein carbon fibers contained in at least one carbon fiber composite material are discontinuous fibers having an average fiber length of 1 to 100 mm.

4. The method for manufacturing a joint member according to claim 3,
wherein the carbon fibers which are discontinuous are two-dimensionally randomly arranged in in-plane directions of the at least one carbon fiber composite material.

5. The method for manufacturing a joint member according to claim 3,
wherein the at least one carbon fiber composite material includes carbon fiber bundles.

6. The method for manufacturing a joint member according to claim 1
wherein the heating and melting are conducted by near infrared rays.

7. The method for manufacturing a joint member according to claim 1,
wherein the carbon fiber composite materials contain the thermoplastic resin in an amount of 50 to 1,000 parts by mass per 100 parts by mass of the carbon fibers.

8. The method for manufacturing a joint member according to claim 1,
wherein at least one of the joining portions A and B is a thickness side wall of the carbon fiber composite materials.

9. A joint member obtained by the manufacturing method of claim 1,
wherein the two or more carbon fiber composite materials containing the thermoplastic resin as a matrix are joined with each other in a joint strength of 10 MPa or more.

10. A method for joining two or more carbon fiber composite materials having a thermoplastic resin as a matrix,
wherein while heating and melting or after heating and melting at least one joining portion A of the carbon fiber composite materials, the one joining portion A is brought into contact with another joining portion B of the carbon fiber composite materials, and
the joining portions A and B are welded by giving vibration or ultrasonic vibration while applying a pressure.

11. A joint member comprising two or more carbon fiber composite materials including a thermoplastic resin as a matrix,
wherein at least one carbon fiber composite material including carbon fibers with an average fiber length of 1 to 100 mm, the carbon fibers two-dimensionally randomly arranged in in-plane directions of the at least one carbon fiber composite material, and
a thickness side wall of the at least one carbon fiber composite material and a thickness side wall or a plate surface of another at least one carbon fiber composite material are joined with a joint strength of 10 MPa or more.
